(19) United States
(12) Patent Application Publication
(10) Pub. No.: US 2007/0127796 A1
(43) Pub. Date: Jun. 7, 2007

(54) System and method for automatically assessing active lesions

(75) Inventors: Maria-Magdalena Nay, Paris (FR); Christophe Loic Genova, Paris (FR); Robert J.S. Johnsen, Oconomowoc, WI (US); Andre Van Nuffel, Dilbeek (BE)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/286,656

(22) Filed: Nov. 23, 2005

(51) Int. Cl. G06K 9/00

(52) U.S. Cl. 382/128

(57) ABSTRACT

Certain embodiments of the present invention provide a method for improving workflow in assessing lesions including displaying a reference image and determining a lesion contour. The reference image is displayed with a user interface component. The lesion contour is determined with a contour processing component. The lesion contour is based at least in part on the reference image and a threshold value.

### BACKGROUND OF THE INVENTION

The present invention generally relates to assessing active lesions. In particular, the present invention relates to a system and method for automatically assessing active lesions.

Medical imaging systems may be used to capture images to assist a physician in making an accurate diagnosis. For example, a physician may use one or more images to visually identify a lesion or other anomalous structure in a patient. As another example, a physician may compare images taken over a series of patient visits to examine the evolution of a structure and/or to evaluate the effectiveness of a treatment. That is, the physician may examine morphological changes, such as changes in size and/or shape, of a lesion to evaluate its characteristics and/or the effectiveness of therapy.

Image data may come from a variety of sources. Images may be generated and/or acquired from one or more imaging sessions and involve different modalities (e.g., ultrasound (US), magnetic resonance (MR), computed tomography (CT), x-ray, positron emission tomography (PET), nuclear, thermal, optical, video, etc.), views, slices, and/or protocols. Images may originate from a single source or be a result of calculation (e.g., fused or compound images from multiple modalities).

An image processing system may combine image exposures with reference data to construct a 3D volumetric data set. The 3D volumetric data set may be used to generate images, such as slices, or a region of interest from the object. For example, the image processing system may produce from the volumetric data sets sagittal, coronal, and/or axial views of a patient's spine, knee, or other area.

PET scanning can be used to generate images representing metabolic activity in, for example, a patient. A radioactive tracer, such as Fluorine-18 2-fluoro-2-deoxy-D-glucose (FDG), may be injected into a patient. FDG mimics glucose and, thus, may be taken up and retained by tissues that require glucose for their activities. Tissues with higher metabolic activity will contain more of the tracer. A PET scanner allows detection of the tracer through its radioactive decay. Thus, by detecting and determining the location of the tracer, a PET scanner can be used to generate images representing metabolic activity.

The resolution of PET data may not be particularly high as compared to other imaging technologies, such as, for example, CT. For example, a voxel in PET data may be 4 mm per axis. In contrast, the voxel size for CT data may be 1 mm. This low resolution makes it difficult to precisely define the location and contours of the detected structures. PET data may be fused with CT data, for example, to aid in locating and evaluating the detected active lesions.

PET scanning is particularly useful in oncology. Areas of the body such as the brain and liver have high metabolic activity, and thus their detection in a PET scan is expected. However, benign inflammatory lesions and malignant lesions have higher than normal metabolic activity as well, and thus can be detected as “hot spots” in PET images. Benign lesions may be distinguished from malignant lesions based on the magnitude of metabolic activity.

A standardized uptake value (SUV) relates to the magnitude of metabolic activity. That is, SUV represents the activity level in a structure and/or lesion. An SUV may be measured for each pixel and/or voxel in a data set, for example. SUV may be measured as SUV by weight (g/ml), SUV by lean body mass (g/ml), or SUV by body surface area (cm2/ml), for example. As mentioned above, a benign lesion may be distinguished from a malignant lesion based on SUV. For example, a malignant lesion may have an SUV by weight greater than 2.5. On the other hand, a benign lesion may have an SUV less than 2.5. Thus, malignant lesions may be recognized by the increased metabolic activity occurring in malignant tissue. The increased activity corresponds to a higher SUV.

Malignant lesions are not homogeneous in metabolic activity. In addition, it is difficult to objectively determine the volume of a lesion. As a result, typically only the maximum SUV pixel value (SUVmax) is used to evaluate a lesion. That is, SUVmax is the maximum SUV pixel value in an area believed to be a lesion. Currently, lesions are typically evaluated (e.g., to determine malignancy) based only on SUVmax.

Currently, two approaches are used to determine SUVmax in an active lesion. One approach involves a user drawing contours of the tumor on each image slice. After the contour of the tumor has been outlined on all slices, SUVmax is determined for the entire volume. This technique is time consuming, as many image slices may be involved. In addition, this technique is subjective in that the user must determine where to draw the contours. The subjectivity may lead to variations in results between users. That is, different users may draw the contours differently, potentially reaching different results.

A second approach to determine SUVmax requires a user to place a box, for example, that encloses the lesion on the image. In some systems, the user merely selects a point and the box is automatically placed around that point with predetermined dimensions. In this approach, the SUVmax is determined based on all of the pixels within the box. This approach may also result in undesirable variations if the box is not carefully placed and/or the box encompasses a structure not related to the lesion of interest.

The use of SUVmax alone to make an evaluation of a lesion is sub-optimal. However, other statistics that might be utilized require better information regarding, for example, the contours and volume, of the lesion being evaluated. Thus, there is a need to accurately and efficiently assess lesions.

### BRIEF SUMMARY OF THE INVENTION

Certain embodiments of the present invention provide a method for improving workflow in assessing lesions including displaying a reference image and determining a lesion contour. The reference image is displayed with a user interface component. The lesion contour is determined with a contour processing component. The lesion contour is based at least in part on the reference image and a threshold value.

In an embodiment, the reference image includes a representation of metabolic activity. Certain embodiments include specifying a focus region. The focus region is specified at least in part on the reference image. The lesion contour is based at least in part on the focus region. In an embodiment, the focus region is specified by a user. In an embodiment, the focus region is specified by an analysis component. In an embodiment, the focus region is based at least in part on a prior lesion assessment. Certain embodiments include computing a lesion statistic based at least in part on the lesion contour and the reference image. In an embodiment, the threshold value is determined at least in part with a histogram. Certain embodiments include displaying the lesion contour with the user interface component. In an embodiment, the user interface component allows the lesion contour to be adjusted based at least in part on input from a user.

Certain embodiments of the present invention provide for a system for assessing lesions including a user interface component and a contour processing component. The user interface component includes a display. The user interface component is capable of presenting a reference image on the display. The contour processing component is in communication with the user interface component. The contour processing component is capable of determining a lesion contour based at least in part on the reference image and a threshold value.

In an embodiment, the reference image includes a representation of metabolic activity. In an embodiment, the user interface component is capable displaying the lesion contour. In an embodiment, the user interface component allows a user to adjust the lesion contour. In an embodiment, the user interface component allows a focus region to be specified. In an embodiment, the lesion contour is based at least in part on the focus region. Certain embodiments include a statistics processing component. The statistics processing component is capable of computing a lesion statistic based at least in part on the lesion contour.

Certain embodiments of the present invention provide for a computer-readable medium including a set of instructions for execution on a computer, the set of instructions including a user interface routine and a contour determination routine for determining a lesion contour. The user interface routine is capable of displaying a reference image. The lesion contour is determined based at least in part on the reference image and a threshold value.

In an embodiment, the user interface routine is capable of displaying the lesion contour. Certain embodiments include a statistics generation routine. The statistics generation routine determines a statistic based at least in part on the lesion contour. In an embodiment, the user interface routine allows a focus region to be specified. In an embodiment, the contour determining routine determines a lesion contour based at least in part on the focus region.

### BRIEF DESCRIPTION OF SEVERAL VIEWS OF THE DRAWINGS

FIG. 1 illustrates an interface for assessing lesions used in accordance with an embodiment of the present invention.

FIG. 2 illustrates an interface for assessing lesions used in accordance with an embodiment of the present invention.

FIG. 3 illustrates an interface for assessing lesions used in accordance with an embodiment of the present invention.

FIG. 4 illustrates a flow diagram for a method for improving workflow in assessing lesions in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

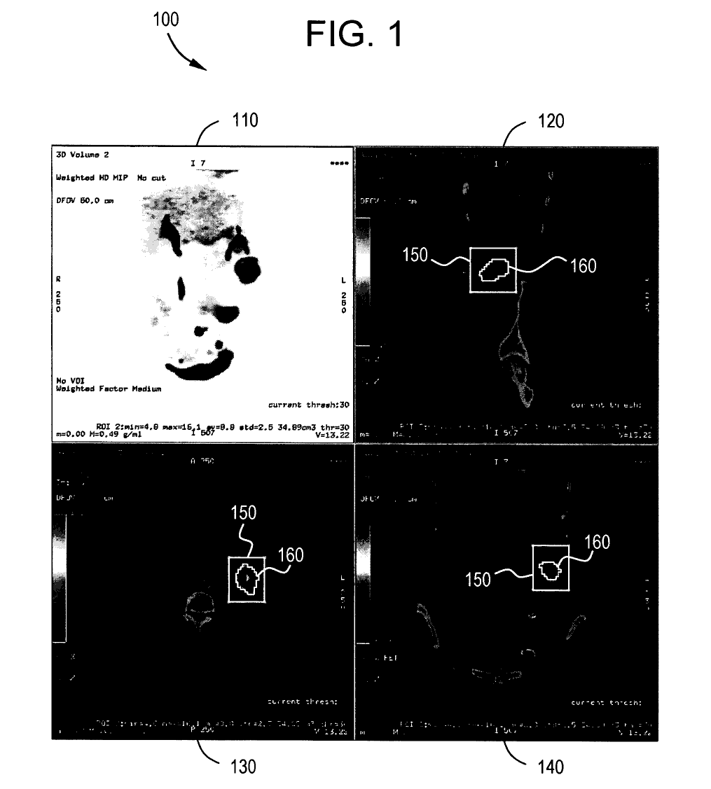

FIG. 1 illustrates an interface 100 for assessing lesions used in accordance with an embodiment of the present invention. The interface 100 includes reference images 110, 120, 130, 140, focus region 150, and lesion contour 160.

For the purposes of illustration only, interface 100 is discussed below with four reference images (110, 120, 130, 140), as illustrated in FIG. 1. It should be understood that interface 100 may include one or more reference images. That is, interface 100 may include reference image 110, reference image 120, reference image 130, and/or reference image 140, and/or other possible reference images or combinations, for example. As another example, interface 100 may include only reference image 120.

A reference image may be displayed and/or presented to a user by a user interface component, for example. The user interface component may be and/or may include a display, a computer monitor, television, or tablet computer, for example. Interface 100 may include or be included in a user interface component.

In an embodiment, focus region 150 is displayed on one or more reference images. The focus region 150 may be overlaid on one or more of the reference images 110, 120, 130, 140, for example. In an embodiment, focus region 150 is displayed on all reference images. In certain embodiments, no focus region 150 is present in interface 100. Focus region 150 may be displayed by a user interface component, for example.

In an embodiment, the lesion contour 160 is displayed on one or more reference images. The lesion contour 160 may be overlaid on one or more of the reference images 110, 120, 130, 140, for example. In an embodiment, the lesion contour 160 is displayed on all reference images. Lesion contour 160 may be displayed by a user interface component, for example.

In operation, interface 100 displays one or more reference images, such as reference images 110, 120, 130, 140. A reference image utilized in the interface 100 may be, for example, axial (e.g., reference image 130), sagittal (e.g., reference image 120), coronal (e.g., reference image 140), or oblique (not shown). A reference image may be generated and/or acquired by an imaging system and/or imaging component utilizing any of a number of imaging modalities. For example, a reference image may be a PET maximum intensity projection (MIP), such as reference image 110. As another example, a reference image may be a generated image such as a fused CT and PET image (e.g., reference image 120).

In an embodiment, a reference image, at least in part, represents and/or contains data about metabolic activity. For example, a reference image may be a PET image containing information about metabolic activity. As another example, a reference image may be a CT image fused with a PET image representing metabolic activity.

In an embodiment, a focus region 150 may be specified. Focus region 150 may be used to indicate an area of a reference image, such as, for example, reference image 120, in which to assess a lesion. Focus region 150 may be overlaid on one or more reference images, for example. Focus region 150 may be triangulated on two or more reference images, for example. That is, the focus region specified on two or more reference images may be coordinated to define an area and/or volume. Thus, focus region 150 may be a volume. Put another way, focus region 150 may represent a volume within a 3D volumetric data set represented by multiple reference images.

The focus region 150 may be represented by a box on a reference image, for example. As another example, the focus region 150 may be represented by an ellipse or other polygon, on a reference image.

Focus region 150 may be displayed by a user interface component, for example. In an embodiment, the focus region 150 may be specified by a user. For example, a user may draw a box to designate the focus region 150. As another example, a user may select a point and a box representing the focus region 150 may be automatically deposited on the reference image. An automatically deposited focus region (based on the selection of a point by a user) may be based on parameters configured previously by the user that specify the dimensions of the box, for example.

In an embodiment, the focus region 150 may be specified by an analysis component (not shown). The analysis component may be in communication with the interface 100. The analysis component may examine a reference image to specify a focus region 150. For example, the analysis component may specify a focus region around a “hot spot” in the reference image without user input. The analysis component may be, for example, a computer-aided diagnosis (CAD) tool.

In an embodiment, the focus region 150 may be based at least in part on a prior lesion assessment. For example, a lesion assessment may be made on a patient prior to treatment. A focus region similar to focus region 150 may be specified as part of the lesion assessment. After treatment, a subsequent lesion assessment may be made to determine, for example, the effectiveness of the treatment. The subsequent lesion assessment may utilize a focus region similar to focus region 150 that is based at least in part on the focus region used in the lesion assessment made prior to the treatment. The focus region used in the subsequent assessment may be automatically specified based at least in part on the focus region used in the prior assessment, for example.

In an embodiment, no focus region 150 is specified. A processing component (not shown) may automatically locate a possible lesion and continue processing the lesion as described below. That is, no focus region may be explicated specified and/or defined. The processing component may be similar to the analysis component, described above, for example.

Lesion contour 160 may be drawn and/or overlaid on one or more reference images, such as, for example, reference images 110, 120, 130, and/or 140. Lesion contour 160 may be displayed by a user interface component, for example. Lesion contour 160 may represent a perimeter around a region of pixels of interest such as a lesion, for example.

Lesion contour 160 may be based at least in part on a threshold value, for example. Lesion contour 160 may encompass pixels of interest where the pixels of interest have an SUV greater than a threshold value, for example. The threshold value may be, for example, the percentage value of the maximum pixel value (e.g., SUVmax). As another example, the threshold value may be a specific SUV value (e.g., threshold value is SUV of 2.5). Lesion contour 160 may be an iso-contour, for example. That is, lesion contour 160 may be drawn through pixels with the same SUV value, such as, for example, the threshold value.

In an embodiment, lesion contour 160 is determined by a contour processing component (not shown). The contour processing component may determine a lesion contour, such as lesion contour 160, based at least in part on a reference image. For example, lesion contour 160 may be determined by a contour processing component based at least in part on metabolic data represented by reference image 120. The contour processing component may utilize a threshold value to determine the lesion contour. That is, the contour processing component may determine pixels of interest based at least in part on a threshold value to determine a lesion contour encompassing the pixels of interest. The threshold value may be similar to the threshold value, described above, for example.

In an embodiment, lesion contour 160 may be adjusted. For example, a user may adjust lesion contour 160 to include and/or exclude pixels. A user may, for example, adjust lesion contour 160 to include pixels with metabolic activity slightly below a threshold value but which the user, after visually examining the image, feels should be included. As another example, lesion contour 160 may be adjusted to exclude pixels that the user feels should not be considered, such as necrotic tissue or part of a healthy organ that also has high metabolic activity, for example. Lesion contour 160 may be adjusted by a user selecting a portion of lesion contour 160 and dragging it with an input device such as a mouse, for example.

Lesion contour 160 may be based at least in part on a focus region. For example, lesion contour 160 may be based on focus region 150. In an embodiment, in determining lesion contour 160, only pixels of interest within focus region 150 may be considered. In an embodiment, pixels outside focus region 150 may be considered in determining lesion contour 160. For example, lesion contour 160 may be determined by considering pixels within focus region 150 along with pixels outside of focus region 150 that are proximate to pixels of interest within focus region 150. As another example, focus region 150 may not completely encompass a lesion. Thus, a lesion contour 160 may be determined that extends beyond focus region 150 to include other pixels which meet the interest requirement (e.g., exceed a threshold value) and are proximate to other determined pixels of interest.

In an embodiment, lesion contour 160 may be stored and/or used for treatment. For example, lesion contour 160 may be saved to a picture archiving and communication system (PACS) or radiology information system (RIS) for later reference. As another example, lesion contour 160 may be utilized for radiotherapy planning.

In an embodiment, a lesion contour from a prior lesion assessment may be overlaid on one or more reference images. For example, a lesion assessment may be made on a patient prior to treatment. A lesion contour similar to lesion contour 160 may be determined as part of the lesion assessment. After treatment, a subsequent lesion assessment may be made to determine, for example, the effectiveness of the treatment. The prior lesion contour may be overlaid and/or drawn on one or more reference images along with the lesion contour from the subsequent assessment to illustrate a change in the lesion contour, for example.

In certain embodiments, a statistics processing component (not shown) is in communication with the interface 100. The statistics processing component may calculate one or more lesion statistics based at least in part on a reference image (e.g., reference image 120, 130, 140). The statistics processing component may calculate a lesion statistic based at least in part on a lesion contour 160. Statistics may include, for example, SUVmax, SUVmin, SUVavg, volume of the lesion, and total lesion glycolysis (TLG). SUVmax, as discussed above, is the maximum SUV pixel value in the lesion, lesion contour, area of interest, and/or focus region, for example. SUVmin and SUVavg are the minimum and average, respectively, SUV pixel values in the lesion, lesion contour, area of interest, and/or focus region, for example. TLG estimates quantitatively global tumor response. The volume of the lesion may be calculated based on a lesion contour and/or focus region, for example. TLG is the product of SUVavg and the volume of the lesion. Lesion statistics may be used to make a better diagnosis of a lesion and/or other anomalous structure and/or to better assess treatment efficacy, for example.

In an embodiment, a lesion statistic is displayed to the user using the interface 100. In an embodiment, the lesion statistic is recomputed and/or redisplayed by the statistics processing component based at least in part on a change in a threshold value, focus region, and/or lesion contour, for example. For example, a user may adjust a focus region or specify a different threshold value. The change in the focus region and/or threshold value may result in a different lesion contour being determined, and thus a new value for TLG (or other statistic) may be computed and/or displayed to the user.

The components and/or functionality of interface 100 and additional components described to be in communication with interface 100 may be implemented alone or in combination in hardware, firmware, and/or as a set of instructions in software, for example. Certain embodiments may be provided as a set of instructions residing on a computer-readable medium, such as a memory or hard disk, for execution on a computer or other processing device, such as, for example, a PACS workstation or image viewer.

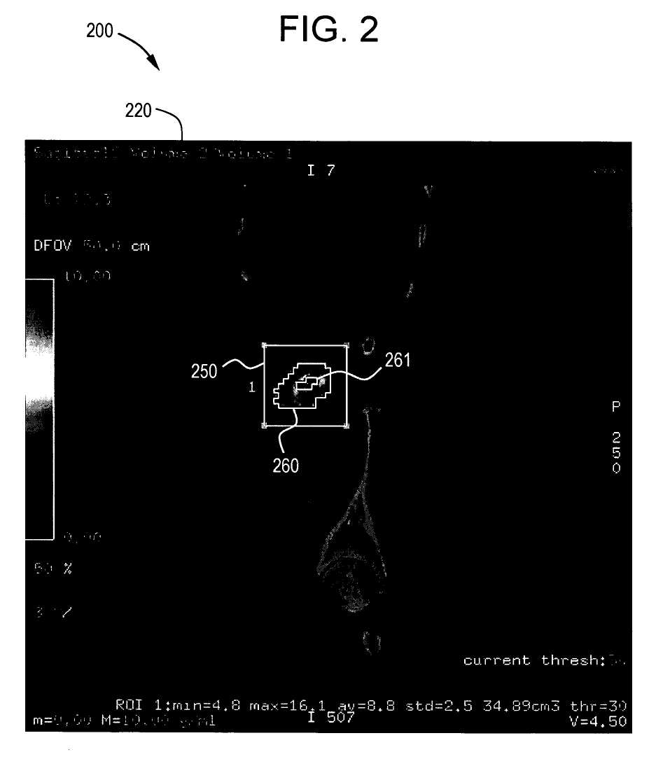

FIG. 2 illustrates an interface 200 for assessing lesions used in accordance with an embodiment of the present invention. The interface 200 includes reference image 220, focus region 250, and lesion contours 260, 261.

Interface 200 may be similar to interface 100, described above, for example. Reference image 220 may be similar to reference image 110, 120, 130, 140, described above, for example. Focus region 250 may be similar to focus region 150, described above, for example. Lesion contours 260, 261 may be similar to lesion contour 160, described above, for example.

In operation, interface 200 illustrates a reference image 220 with a focus region 250 overlaid on reference image 220. In addition, interface 200 illustrates lesion contours 260, 261 overlaid on reference image 220.

As indicated, FIG. 2 contains two lesion contours (260, 261). Lesion contour 260 may be similar to lesion contour 160, described above, for example. Lesion contour 260 describes the “outer” edge of the lesion. The lesion illustrated in FIG. 2 includes necrotic tissue. The necrotic tissue is dead and thus does not exceed the metabolic activity threshold. Thus, it would typically not be included in calculating statistics for the lesion. However, because the necrotic tissue is encompassed by the active lesion, a second lesion contour, lesion contour 261, is used to describe the “inner” edge of the lesion. Thus, the volume, and other statistics, for the lesion may include the area within the “outer” lesion contour 260, but exclude the area within the “inner” lesion contour 261, for example.

In certain embodiments, a user may desire the necrotic tissue to be included in the calculation of one or more statistics. The user may remove the lesion contour 261 so the entire area is included in the calculation, for example. As an alternative, certain statistics may be calculated using the volume defined by only the “outer” lesion contour 260, ignoring the presence of an “inner” lesion contour 261. For example, a user may want to compute the volume and/or total mass of the lesion. As another example, the “inner” lesion contour 261 may be ignored for radiotherapy treatment purposes.

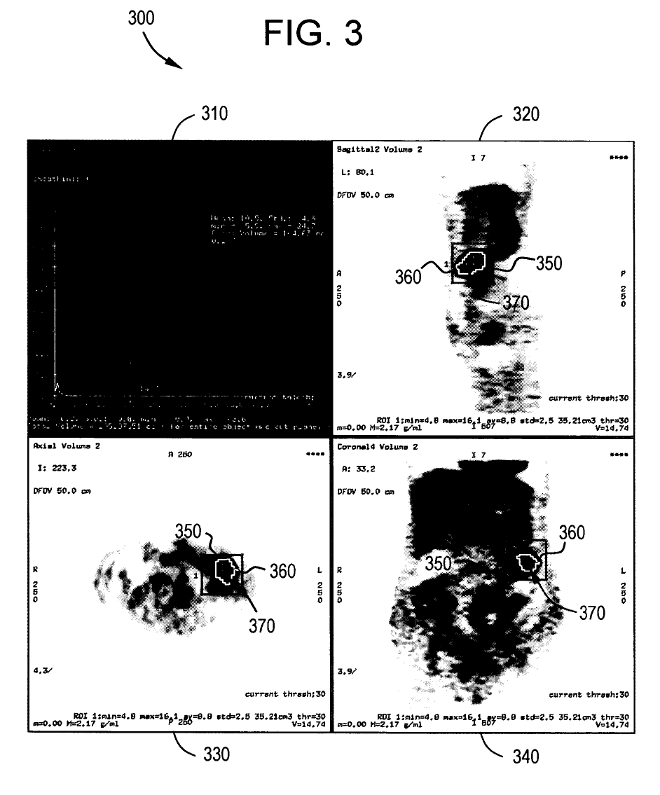

FIG. 3 illustrates an interface 300 for assessing lesions used in accordance with an embodiment of the present invention. The interface 300 includes histogram 310, reference images 320, 330, 340, focus region 350, lesion contour 360, and lesion pixels 370.

Interface 300 may be similar to interface 100, described above, for example. Reference images 320, 330, 340 may be similar to reference images 110, 120, 130, 140, described above, for example. Focus region 350 may be similar to focus region 150, described above. Lesion contour 360 may be similar to lesion contour 160, described above, for example.

In operation, interface 300 illustrates focus region 350 overlaid on reference images 320, 330, 340. In addition, interface 300 illustrates lesion contour 360 overlaid on reference images 320, 330, 340. Also, interface 300 illustrates lesion pixels 370 overlaid on reference images 320, 330, 340.

Histogram 310 may include a representation of the frequency of pixel values. For example, histogram 310 may represent on the y-axis the number of occurrences or percentage of total occurrences of each pixel value, arranged from lowest to highest, on the x-axis. As another example, the x-axis may represent the percentage value of the maximum pixel value (e.g., SUVmax). The pixel values may be for one or more pixels in the reference image, such as reference image 320, 330, and/or 340, for example. The pixel values may be for pixels in the focus region 350, for example. As discussed above, pixel values may represent SUV, for example.

Histogram 310 may be used to indicate a threshold value, for example. In an embodiment, a user selects a portion of the histogram 310 to specify a threshold value. In an embodiment, the current threshold value is indicated on histogram 310. The threshold value may be indicated by a vertical line crossing the x-axis at the threshold value, for example.

Lesion pixels 370 may be displayed on a reference image, such as reference image 320, 330, and 340, for example. Lesion pixels 370 represent pixels of interest, similar to pixels of interest discussed above. Lesion pixels 370 may indicate, for example, pixels in a reference image that exceed a threshold value. Alternatively, lesion pixels 370 may indicate pixels that do not exceed a threshold value. Alternatively, lesion pixels 370 may indicate pixels that equal a threshold value. The threshold value may be the threshold value indicated and/or specified by histogram 310. Lesion pixels 370 may be determined by a contour processing component, for example. Lesion pixels 370 may be displayed by a user interface component, for example.

Lesion contour 360 describes the perimeter of lesion pixels 370. Lesion contour 360 may be similar to lesion contour 160, described above, for example. Lesion contour 360 may be determined by a contour processing component, for example. Lesion contour 360 may be displayed by a user interface component, for example.

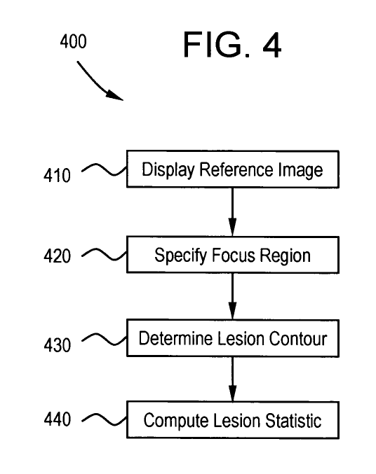

FIG. 4 illustrates a flow diagram for a method 400 for improving workflow in assessing lesions in accordance with an embodiment of the present invention. The method 400 includes the following steps, which will be described below in more detail. First, at step 410, a reference image is displayed. Then, at step 420, a focus region is specified. Next, at step 430, a lesion contour is determined. At step 440, a lesion statistic is computed. The method 400 is described with reference to elements of systems described above, but it should be understood that other implementations are possible.

First, at step 410, a reference image is displayed. The reference image may be similar to reference image 110, 120, 130, 140, described above, for example. The reference image may be displayed and/or presented to a user by a user interface component. The user interface component may be and/or may include a display, a computer monitor, television, or tablet computer, for example. The user interface component may include and/or be included in an interface similar to interfaces 100, 200, and/or 300, described above, for example.

Then, at step 420, a focus region is specified. The focus region may be similar to focus regions 150, 250, and/or 350, described above, for example. The focus region may be displayed on a user interface component. The focus region may be overlaid on a reference image, for example.

In an embodiment, the focus region is specified by a user. For example, a user may draw a box on the reference image to indicate the focus region. As another example, a user may select a point and a focus region may be drawn automatically based at least in part on the point selected by the user. The focus region may be based at least in part on configurable parameters. The parameters may be configured by a user, for example. The parameters may include typical dimensions for a lesion centered about a point, for example.

In an embodiment, the focus region may be determined automatically. The focus region may be determined by an analysis component, for example. The analysis component may be similar to the analysis component described above, for example. The analysis component may be, for example, a computer-aided diagnosis (CAD) tool.

Next, at step 430, a lesion contour is determined. The lesion contour may be similar to lesion contour 160 and/or lesion contour 360, described above, for example. The lesion contour may be determined by a contour processing component, for example. The lesion contour may be displayed by a user interface component, for example. The lesion contour may be based at least in part on a reference image, for example. The reference image may be the reference image displayed at step 410, described above, for example. The lesion contour may be based at least in part on a threshold value, for example. The lesion contour may be based at least in part on a focus region, for example. The focus region may be the focus region determined at step 420, for example. The lesion contour may be an iso-contour, for example. That is, the lesion contour may be drawn through pixels with the same SUV value, such as, for example, the threshold value.

At step 440, a lesion statistic is computed. In an embodiment, the lesion statistic is computed by a statistics processing component. The statistics processing component may be similar to the statistics processing component described above, for example. In an embodiment, the lesion statistic is based at least in part on a focus region. The focus region may be the focus region specified at step 420, for example. In an embodiment, the lesion statistic is based at least in part on a reference image. The reference image may be the reference image displayed in step 410, described above, for example. In an embodiment, the lesion statistic is based at least in part on a lesion contour. The lesion contour may be the lesion contour determined in step 430, for example. The lesion statistic may include statistics such as, for example, SUVmax, SUVmin, SUVavg, lesion volume, and/or TLG, as described above. In an embodiment, the statistic is displayed to the user using a user interface component.

In an embodiment, the lesion statistic is recomputed based at least in part on a change in a threshold value, focus region, and/or lesion contour, for example. For example, a user may adjust a threshold value using a histogram (e.g., histogram 310, described above). The change in the threshold value may result in a different lesion contour being determined, and thus a new value for TLG may be computed and/or displayed to the user.

The steps and/or components of method 400 may be implemented alone or in combination in hardware, firmware, and/or as a set of instructions in software, for example.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for improving workflow in assessing lesions, the method including:
displaying a reference image with a user interface component; and
determining a lesion contour with a contour processing component, wherein the lesion contour is based at least in part on the reference image and a threshold value.

2. The method of claim 1, wherein the reference image includes a representation of metabolic activity.

3. The method of claim 1, further including specifying a focus region, wherein the focus region is specified at least in part on the reference image, wherein the lesion contour is based at least in part on the focus region.

4. The method of claim 3, wherein the focus region is specified by a user.

5. The method of claim 3, wherein the focus region is specified by an analysis component.

6. The method of claim 3, wherein the focus region is based at least in part on a prior lesion assessment.

7. The method of claim 1, further including computing a lesion statistic based at least in part on the lesion contour and the reference image.

8. The method of claim 1, wherein the threshold value is determined at least in part with a histogram.

9. The method of claim 1, further including displaying the lesion contour with the user interface component.

10. The method of claim 9, wherein the user interface component allows the lesion contour to be adjusted based at least in part on input from a user.

11. A system for assessing lesions, the system including:
a user interface component, wherein the user interface component includes a display, wherein the user interface component is capable of presenting a reference image on the display; and
a contour processing component, wherein the contour processing component is in communication with the user interface component, wherein the contour processing component is capable of determining a lesion contour based at least in part on the reference image and a threshold value.

12. The system of claim 11, wherein the reference image includes a representation of metabolic activity.

13. The system of claim 11, wherein the user interface component is capable displaying the lesion contour.

14. The system of claim 13, wherein the user interface component allows a user to adjust the lesion contour.

15. The system of claim 11, wherein the user interface component allows a focus region to be specified, wherein the lesion contour is based at least in part on the focus region.

16. The system of claim 11, further including a statistics processing component, wherein the statistics processing component is capable of computing a lesion statistic based at least in part on the lesion contour.

17. A computer-readable medium including a set of instructions for execution on a computer, the set of instructions including:
a user interface routine capable of displaying a reference image; and
a contour determination routine for determining a lesion contour, wherein the lesion contour is determined based at least in part on the reference image and a threshold value.

18. The set of instructions of claim 17, wherein the user interface routine is capable of displaying the lesion contour.

19. The set of instructions of claim 17, further including a statistics generation routine, wherein the statistics generation routine determines a statistic based at least in part on the lesion contour.

20. The set of instructions of claim 17, wherein the user interface routine allows a focus region to be specified.

21. The set of instructions of claim 20, wherein the contour determining routine determines a lesion contour based at least in part on the focus region.
